(19) United States
(12) Patent Application Publication
(10) Pub. No.: US 2016/0242100 A1
(43) Pub. Date: Aug. 18, 2016

(54) WIRELESS NETWORK FREE PUSH DATA

(71) Applicant: GainSpan Corporation, San Jose, CA (US)

(72) Inventors: Lewis E. ADAMS, III, San Jose, CA (US); Alan J. HERRING, San Jose, CA (US); Pankanj VYAS, San Jose, CA (US)

(21) Appl. No.: 14/663,332

(22) Filed: Mar. 19, 2015

Related U.S. Application Data
(60) Provisional application No. 62/117,633, filed on Feb. 18, 2015.

(51) Int. Cl. H04W 40/34; H04L 12/703; H04W 4/00

(52) U.S. Cl. CPC H04W 40/34; H04W 4/008; H04L 45/28; H04W 84/12

(57) ABSTRACT

A system includes a transmitter, a device and a wireless network. The device is coupled to the transmitter by a set of wireless communication protocols. The wireless network is coupled to the device by a set of wireless communication export protocols. The wireless communication protocols and the wireless communication export protocols include 802.11 WiFi, WiFi, ZigBee and Bluetooth.

### CROSS-REFERENCE TO RELATED APPLICATION

This application claims the benefit under 35 U.S.C. §119(e) to U.S. Provisional Patent Application No. 62/117,633 entitled “WIRELESS NETWORK FREE PUSH DATA,” filed on Feb. 18, 2015, the disclosure of which is expressly incorporated by reference herein in its entirety.

### TECHNICAL FIELD

The present disclosure generally relates to wireless systems. More specifically, the present disclosure relates to wireless network free push data.

### BACKGROUND

For wireless systems or devices, transferring data efficiently while conserving power is a key concern. Wireless communication protocols such as ZigBee, Bluetooth and 802.11 WiFi may be used for different applications. However, certain protocols such as ZigBee or Bluetooth are more suited for low bandwidth, close-range communications with devices that may not require a network, whereas other protocols such as 802.11 WiFi may be better suited for high bandwidth, long-range communications with devices in a large and broad network.

Furthermore, some wireless communication protocols may utilize and consume more power when compared to other wireless communication protocols. A given wireless communication protocol is most ideally used when it communicates with a device within its target range. For instance, ZigBee and Bluetooth should be used for devices located at a closer range, with WiFi being used for devices located farther away. In addition, if a wireless communication protocol does not need to be turned on or have to send messages all the time, then shutting off the wireless communication protocol when it is not in use will conserve the most power.

In order to ensure the most efficient use of wireless communication protocols, a wireless network may or may not be used. Many times data that is broadcasted unilaterally from a transmitter, known as push data, is sent over a wireless communication protocol that requires too much bandwidth, power and/or resources. Such push data may also require a wireless network, which may lead to a slower transfer due to network congestion and traffic. Furthermore, because the push data is being transmitted over heavily occupied frequency channels, the FCC may hinder the bandwidth used by the wireless network with restrictions or other regulations. Therefore, an approach to transmit data, such as push data, efficiently and without the limitations of wireless networks is desired.

### SUMMARY

In one aspect, a system includes a transmitter, a device and a wireless network. The device is coupled to the transmitter by a set of wireless communication protocols. The wireless network is coupled to the device by a set of wireless communication export protocols.

Another aspect discloses a method using wireless communication protocols. The method includes receiving data on at least two wireless communication protocols. The method also includes performing actions based on the received data. The method also includes transmitting data on at least two wireless communication export protocols.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a schematic diagram of a device using various wireless communication protocols according to an aspect of the present disclosure.

FIG. 2 is a schematic diagram of a device in communication with a transmitter and using various wireless communication protocols according to an aspect of the present disclosure.

FIG. 3 is a schematic diagram of a device in communication with a transmitter and using various wireless communication protocols according to an aspect of the present disclosure.

FIG. 4 is a schematic diagram of a device in communication with a transmitter and using various wireless communication protocols according to an aspect of the present disclosure.

FIG. 5 is a schematic diagram of a device in communication with a transmitter and using various wireless communication protocols according to an aspect of the present disclosure.

FIG. 6 is a process flow diagram illustrating a method of using a transmitter to communicate with a device using various wireless communication protocols, according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Overview

The present disclosure describes systems that are able to communicate efficiently using wireless communication protocols with or without wireless networks. By being able to communicate in a wireless fashion without a wireless network using a close-range wireless protocol such as ZigBee, information is more efficiently sent. For example, push data—which is characterized as data broadcasted unilaterally from a transmitter or other source—may be more efficiently sent and received with a close-range wireless protocol that does not rely on a wireless network.

In one implementation, information, data or messages such as push data can be sent from the transmitter or source to the device via a number of different wireless communication protocols. However, the appropriate wireless communication protocol is chosen according to the appropriate context, range and particular application in order to conserve power and resources. In addition, the device may also use a number of different wireless communication protocols to communicate with a wireless network, other devices, a cloud or other entities. The different wireless communication protocols reinforce one another. In other words, in case one wireless communication protocol fails or goes down, then another wireless communication protocol is there to take its place. Having multiple wireless communication protocols serve as auxiliary or parallel channels of one another increases the robustness and efficiency of the overall system.

Device Connected to Wireless Communication Protocols

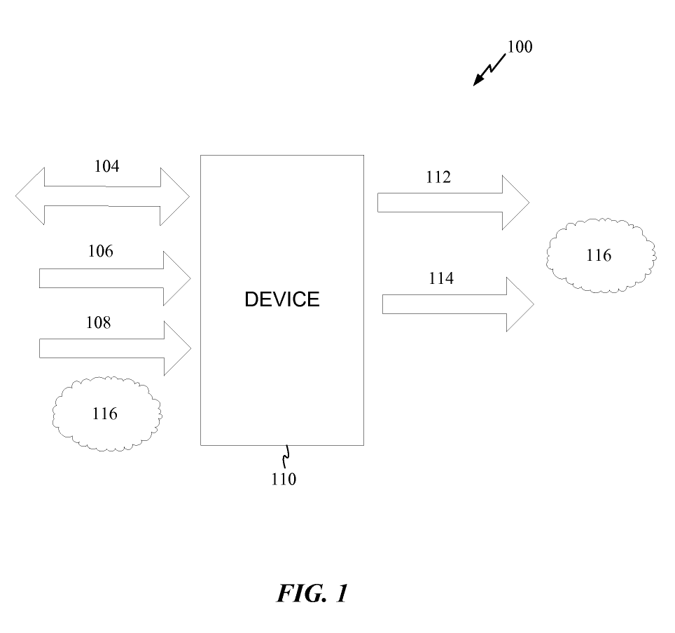

FIG. 1 is a schematic diagram 100 of a device 110 using various wireless communication protocols according to an aspect of the present disclosure.

Device 110 may receive information or messages via bidirectional close-range protocol 104, unidirectional close-range protocol 106, or long-range protocol 108. The long-range protocol 108 may also be assisted by wireless network 116, which may include other devices, including remote controls, or connections to other devices.

An example of the bidirectional close-range protocol 104 is a ZigBee or Bluetooth connection because all that is required is the device 110 and another device (not shown) in communications with one another. In other words, the bidirectional close range protocol 104 does not require a wireless network to effectuate communications. This also means that the bidirectional close range protocol 104 uses less bandwidth (close to none), much less power and less resources compared to a wireless network protocol connection. The bidirectional close range protocol 104 also does not have congestion or traffic because it is not on a network, and would not be using frequency channels regulated by the FCC.

An example of the unidirectional close-range protocol 106 is ZigBee. For instance, the device 110 could be a smartphone and a store could be broadcasting an advertisement or similar message when the device 110 is within close proximity of the store, and within the necessary range for ZigBee transmissions. The unidirectional close-range protocol 106 also does not require a wireless network to communicate with the device 110. However, the device 110 must be close enough to the source broadcasting information via the unidirectional close-range protocol 106 in order to receive messages or information from it. The unidirectional close-range protocol 104 also has the advantages of less bandwidth, less power consumption, virtually no congestion or traffic, and not being on a frequency channel regulated by the FCC.

An example of the long-range protocol 108 is a 802.11 WiFi or WiFi connection. The long-range protocol 108 may also utilize the wireless network 116. For instance, the device 110 could be a smartphone and a store located far away from the device 110 (but in the same mall where the device 110 is present) could be broadcasting an advertisement. By using the wireless network 116, the advertisement broadcasted by that store will reach the device 110 via the long-range protocol 108.

However, the long-range protocol 108 compared to the close-range protocols of 104 and 106 may utilize more power, more resources, more bandwidth, and have frequency channels that may be regulated by the FCC. As a result, there are restrictions and costs associated with bandwidth usage over a wireless network 116 via long-range protocol 108. Therefore, the long-range protocol 108 should only be used when necessary—such as for performing long-distance communications—in order to conserve resources and power.

The device 110 may also use long-range export protocol 112 and close-range export protocol 114 to communicate with the wireless network 116 or other devices, which may also be located in the wireless network 116. An example of the long-range export protocol 112 is 802.11 WiFi or WiFi, as discussed above. The long-range export protocol 112 may both use the wireless network 116 as well as send information from the device 110 to the wireless network 116, or another device or receiver located within the wireless network 116. An example of the close-range export protocol 114 is ZigBee. In this case, the ZigBee connection would not need to use the wireless network 116 due to the nature of a ZigBee connection, but the device 110 may be communicating or sending information to another device or receiver within the wireless network 116 over the close-range export protocol 114. For instance, the device 110 may be sending information to another smartphone or device, or there may be a receiver in a store in the wireless network 116 that receives confirmation of user participation with regards to its advertisements.

Remote Control and Device with Wireless Communication Protocols

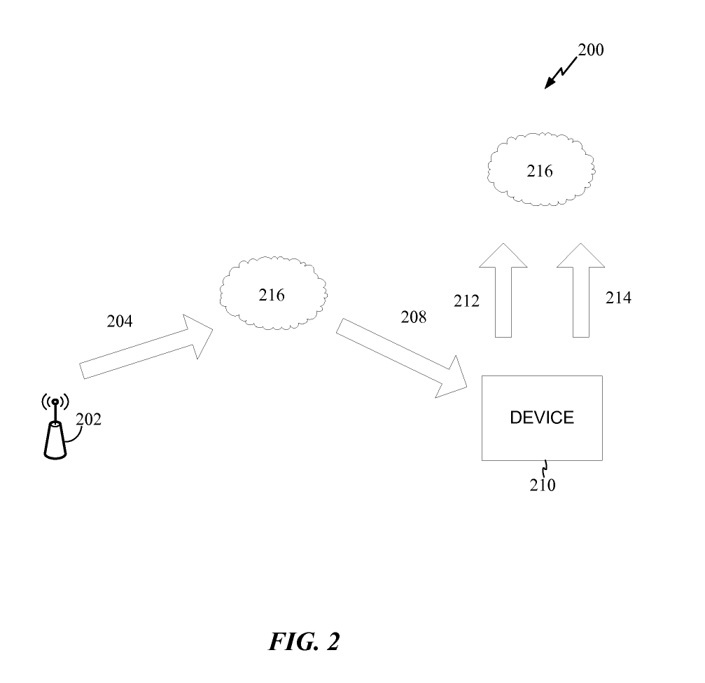

FIG. 2 is a schematic diagram 200 of a device 210 in communication with a transmitter 202 and using various wireless communication protocols according to an aspect of the present disclosure.

The transmitter 202 can send data, information and messages to device 210 via a network export protocol 204, a wireless network 216 and a network import protocol 208. An example of the network export protocol 204 and the network import protocol 208 is 802.11 WiFi or WiFi, as discussed above. The network export protocol 204 takes data from the transmitter 202 and sends it to the wireless network 216. The network import protocol 208 takes data from the wireless network 216 and sends it to the device 210. Because the network export protocol 204 and then network import protocol 208 rely on the wireless network 216, the transmission of data may be slower due to network congestion or traffic. The transmission of data over the wireless network 216 may also involve more power, more bandwidth, and more resources. Frequency channels of data transmitted over the wireless network 216 may also be hindered with restrictions or regulations from the FCC.

Push data may also be transmitted from the transmitter 202 to eventually reach the device 210. Push data is data broadcast from the transmitter 202 unilaterally to any receiver configured to receive such data, such as device 210. An example of push data is a set of advertisements broadcast from the transmitter 202, which may be located in a store. The device 210 may be a smartphone device, and when the device 210 is in the same mall or space as the transmitter 202, then the device 210 receives the advertisement or coupon as push data transmitted from the transmitter 202 in a store.

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. The long-range export protocol 212 may both use the wireless network 216 as well as send information from the device 210 to the wireless network 216, or another device or receiver located within the wireless network 216. An example of the close-range export protocol 214 is ZigBee. In this case, the ZigBee connection would not need to use the wireless network 216 due to the nature of a ZigBee connection, but the device 210 may be communicating or sending information to another device or receiver within the wireless network 216 over the close-range export protocol 214. For instance, the device 210 may be a camera sending data about its recorded video or taken shots to a computer for downloading and analysis. The device 210 may also be a smartphone that sends information to another smartphone or device, or there may be a receiver in a store in the wireless network 216 that receives confirmation of user participation with regards to its advertisements.

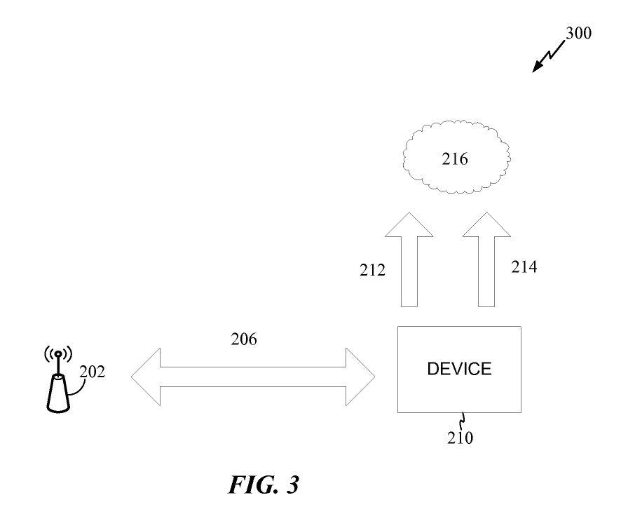

FIG. 3 is a schematic diagram 300 of a device 210 in communication with a transmitter 202 and using various wireless communication protocols according to an aspect of the present disclosure.

The transmitter 202 may use a bidirectional close-range protocol 206 in order to send data, messages or information to the device 210. An example of the bidirectional close-range protocol 206 is a ZigBee or Bluetooth connection. ZigBee or Bluetooth connections only require the remote control 202 and the device 210 to be in communications with one another. In other words, a wireless network is not necessary. Therefore, communications can take place between the transmitter 202, such as a remote control, and the device 210 much faster, with much less power consumption, and at a lower bandwidth. There may also be no FCC requirements or regulations on a ZigBee connection. Less resources are also utilized because the communications are made at a relatively close range. An example would be if the device 210 was a camera, and the transmitter 202 was located in somewhat close proximity to the camera and configured to send the camera instructions such as turning on or off, or when to record video or shoot images. The bidirectional close-range protocol 206 may also involve the first submission of a message over Zigbee from the transmitter 202 to the device 210, and then an acknowledgment message (or “ACK” message), sent back in response from the device 210 to the transmitter 202.

In the context of push data, the use of the bidirectional close-range protocol 206 allows the efficient transfer of push data from a transmitter 202 to a device 210 without the use of a wireless network, such as wireless network 216. Also because the transmitter 202 and the device 210 are connected via a bidirectional close-range protocol 206 such as a ZigBee connection, transfer of data between the two entities is made much faster and at much lower bandwidth when compared to a transmission over a wireless network. In addition, less power and less resources are consumed when transmitting data over the bidirectional close-range protocol. The bidirectional close-range protocol is also unhindered by regulations or restrictions from the FCC. An example of the bidirectional close-range protocol 206 in the context of push data is if the transmitter 202 was located in a store and was broadcasting advertisements or coupons as its push data. The device 210 may be a smartphone configured to receive such advertisements or coupons. When the user carrying the device 210 walks past or gets near the store with the transmitter 202, their device 210 receives the advertisement or coupon. The range or distance between the transmitter 202 and the device 210 which enables the device 210 to receive data from the transmitter 202 may be set according to standards or settings related to the bidirectional close-range protocol 206 (e.g., ZigBee or Bluetooth specifications).

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. An example of the close-range export protocol 214 is ZigBee, also as discussed above.

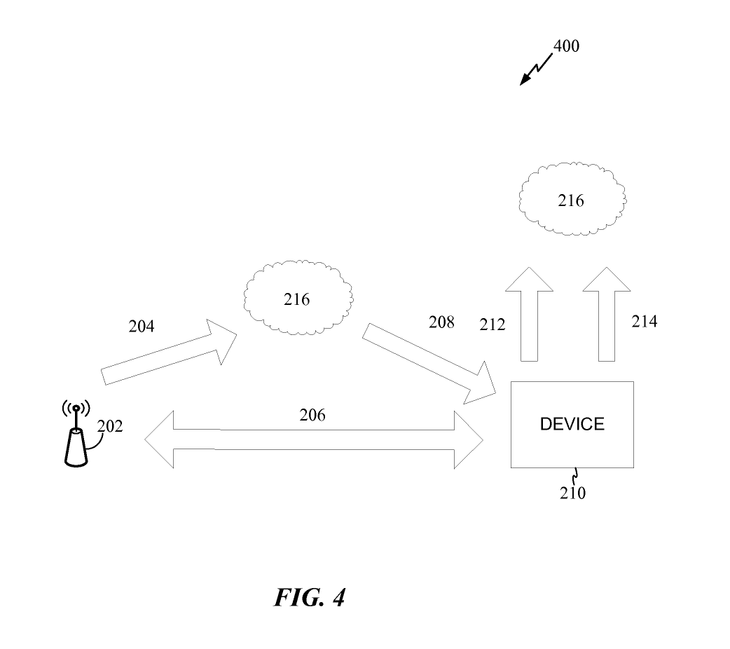

FIG. 4 is a schematic diagram 400 of a device 210 in communication with a transmitter 202 and using various wireless communication protocols according to an aspect of the present disclosure.

As shown in FIG. 4, the transmitter 202 may communicate with the device 210 by means of both a bidirectional close-range protocol 206 and the set of the network export protocol 204, the wireless network 216 and the network import protocol 208. Both the bidirectional close-range protocol 206 and the network protocols 204 and 208 are described above. However, being able to use both simultaneously has a number of advantages. First, in case one of the protocols 204-208 or 206 fails or drops off, another one is able to cover it. This is particularly useful when an important piece of information needs to be transmitted between the transmitter 202 and the device 210. By using both the close-range and long-range channels as auxiliary or parallel channels, the security of information transfer between the transmitter 202 and the device 210 is secured, as well as made more efficient. Another advantage is that information suited for a particular wireless communication protocol can be sent via a selected wireless communication protocol when appropriate, in order to make data communications more efficient. For instance, if the data is large and needs to be sent in a short amount of time, the ZigBee connection of the bidirectional close-range protocol 206 may be used as the quickest form of transfer. On the other hand, if the data is relatively small and can be sent over longer periods of time, then the WiFi connection of the network protocols 204 and 208 may be used as the quickest form of transfer, with the wireless network 216 also being used to facilitate or further distribute the process.

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. An example of the close-range export protocol 214 is ZigBee, also as discussed above. Also, similar to what was discussed above, having both the long-range export protocol 212 and the close-range export protocol 214 be available simultaneously has advantages for security and efficiency purposes. For example, if one of the export protocols 212 or 214 fails or drops out, then the other one can cover. Furthermore, depending on the data to be sent, the appropriate export protocol out of 212 or 214 will be used in order to ensure the most efficient use of resources and power.

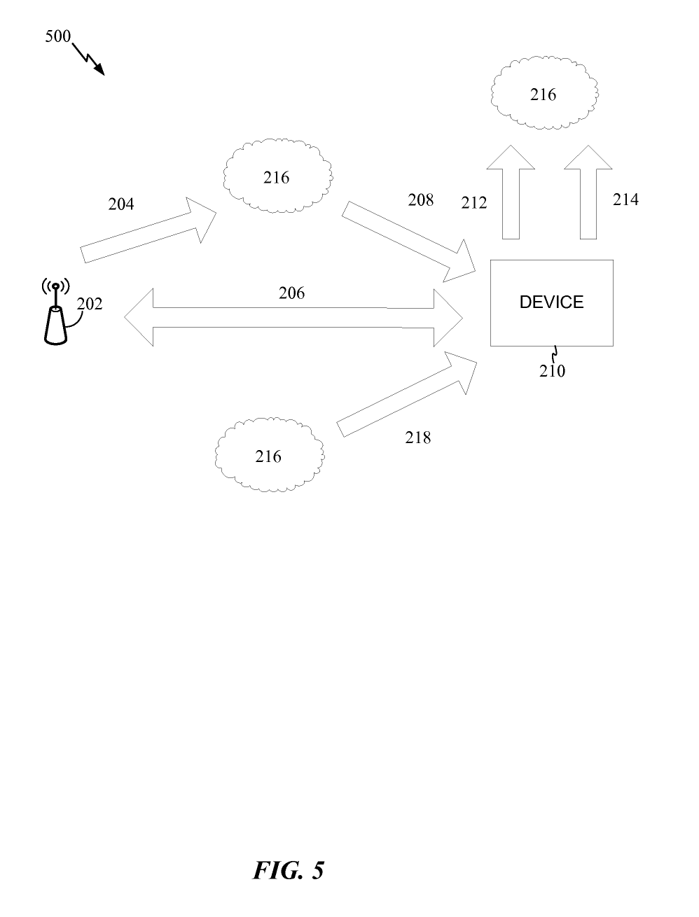

FIG. 5 is a schematic diagram 500 of a device 210 in communication with a transmitter 202 and using various wireless communication protocols according to an aspect of the present disclosure.

As shown in FIG. 5, the transmitter 202 may communicate with the device 210 by means of both a bidirectional close-range protocol 206 and the set of the network export protocol 204, the wireless network 216 and the network import protocol 208. Both the bidirectional close-range protocol 206 and the network protocols 204 and 208 are described above, as well as the advantages of being able to use both simultaneously. A long-range protocol 218 is available in case the device 210 needs to download any information directly from the wireless network 216. The long-range protocol 218 could also be used in case the wireless network 216 contains another transmitter broadcasting content, and the device 210 is configured as a receiver of that content, being able to receive it as long as it is within the range of the long-range protocol 218. Examples of the long-range protocol 218 include 802.11 WiFi and WiFi. However, any type of long-range wireless communication protocol may be used.

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. An example of the close-range export protocol 214 is ZigBee, also as discussed above. Also, similar to what was discussed above, having both the long-range export protocol 212 and the close-range export protocol 214 be available simultaneously has advantages for security and efficiency purposes. For example, if one of the export protocols 212 or 214 fails or drops out, then the other one can cover it. Furthermore, depending on the data to be sent, the appropriate export protocol out of 212 or 214 will be used in order to ensure the most efficient use of resources and power.

In this fashion, the push data may be wireless network free in that transmission of it would not require a wireless network. In addition, the push data may also use the wireless network to be transmitted, if desired. The wireless communication protocol that will be used for a data transmission will be tailored specifically to the type of data being transmitted. By having both options available, the transmission of push data will be efficient and allocate power consumption and use of resources effectively.

Process Flow

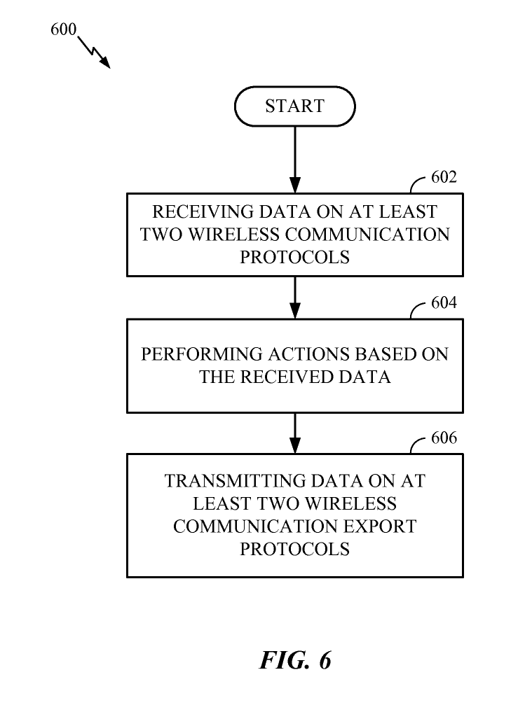

FIG. 6 is a process flow diagram illustrating a method 600 of using a transmitter to communicate with a device using various wireless communication protocols, according to an aspect of the present disclosure.

In block 602, data is received on at least two wireless communication protocols. In block 604, actions are performed based on the received data. In block 606, data is transmitted on at least two wireless communication export protocols.

As previously discussed, in some cases, long range protocols like WiFi have stronger security credentials in comparison to close range protocols. According to aspects of the present disclosure, a transmitter and receiver use a long range protocol to setup a secured channel. Furthermore, the transmitter and receiver may share credentials on the secured channel which can be used for communication via a short range communication protocol. Additionally, after sharing the credentials, the transmitter may use the short range protocol for communication. In one configuration, the data is encrypted using the credentials which were acquired via the long range communication.

Additionally, in one configuration, communications via short range protocols trigger communications via the long range protocols. For example, after an event is detected at the transmitter, the transmitter may communicate with the receiver to indicate that communication will begin via the long range protocol. Accordingly, the receiver switches to the long range communication circuitry based on the indication from the transmitted. Specifically, the long range communication circuitry may be enabled when specified for use, thereby improving power use by conserving the use of the high power long range communication circuitry.

Implementation Alternatives

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The foregoing description of one or more embodiments or aspects of the present disclosure has been presented for the purposes of illustration and description. It is not intended to be exhaustive or to limit the disclosure or the invention to the precise form disclosed. Many modifications and variations are possible in light of the above teaching. Although the present disclosure and invention has been described in connection with certain embodiments, it is to be understood that modifications and variations may be utilized without departing from the principles and scope of the disclosure or invention, as those skilled in the art will readily understand. Accordingly, such modifications would be practiced within the scope of the disclosure and invention, and within the scope of the following claims or within the full range of equivalents of the claims.

Further, the attached claims are presented merely as one aspect of the present invention. No disclaimer is intended, expressed, or implied for any claim scope of the present invention through the inclusion of this or any other claim language that is presented herein or may be presented in the future. Any disclaimers, expressed or implied, made during prosecution of the present application regarding the claims presented, changes made to the claims for clarification, or other changes made during prosecution, are hereby expressly disclaimed for at least the reason of recapturing any potential disclaimed claim scope affected by presentation of specific claim language during prosecution of this and any related applications. Applicant reserves the right to file broader claims, narrower claims, or claims of different scope or subject matter, in one or more continuation or divisional applications in accordance within the full breadth of the present disclosure, and the full range of doctrine of equivalents of the present disclosure, as recited in this specification.

What is claimed is:

1. A system, comprising:
a transmitter;
a device coupled to the transmitter by a plurality of wireless communication protocols; and
a wireless network coupled to the device by a plurality of wireless communication export protocols.

2. The system of claim 1, in which the plurality of wireless communication protocols comprises a network export protocol, a network import protocol and a close-range wireless communication protocol.

3. The system of claim 2, in which the transmitter is further coupled to the wireless network by the network export protocol, and the device is coupled to the wireless network by the network import protocol.

4. The system of claim 1, in which the plurality of wireless communication export protocols comprises a long-range wireless export communication protocol and a close-range wireless export communication protocol.

5. The system of claim 2, in which the network export protocol and the network import protocol is 802.11 WiFi.

6. The system of claim 2, in which the close-range wireless communication protocol comprises ZigBee and Bluetooth.

7. The system of claim 4, in which the long-range wireless communication export protocol is 802.11 WiFi.

8. The system of claim 4, in which the close-range wireless export communication protocol comprises ZigBee and Bluetooth.

9. The system of claim 1, in which the wireless network is directly coupled to the device by a long-range protocol.

10. The system of claim 9, in which the long-range protocol is 802.11 WiFi.

11. A method to communicate over wireless communication protocols, comprising:
receiving data on at least two wireless communication protocols;
performing actions based on the received data; and
transmitting data on at least two wireless communication export protocols.

12. The method of claim 11, in which the at least two wireless communication protocols comprises a network export protocol, a network import protocol and a close-range wireless communication protocol.

13. The method of claim 12, in which the network export protocol and the network import protocol is 802.11 WiFi.

14. The method of claim 12, in which the close-range wireless communication protocol comprises ZigBee and Bluetooth.

15. The method of claim 11, in which:
the at least two wireless export communication protocols comprise a long-range wireless export communication protocol and a close-range wireless communication protocol, and
the data is transmitted to a wireless network.

16. The method of claim 15, in which the long-range wireless export communication protocol is 802.11 WiFi.

17. The method of claim 15, in which the close-range wireless export communication protocol comprises ZigBee and Bluetooth.

18. The method of claim 11, further comprising:
receiving data from a wireless network via a long-range protocol.

19. The method of claim 18, in which the long-range protocol is 802.11 WiFi.

20. The method of claim 11, further comprising:
switching to a second wireless communication protocol of the at least two wireless communication protocols when a first wireless communication protocol of the at least two wireless communication protocols fails; and
switching to a second wireless export communication protocol of the at least two wireless export communication protocols when a first wireless export communication protocol of the at least two wireless export communication protocols fails.
